(19) United States
(12) Patent Application Publication
(10) Pub. No.: US 2005/0080665 A1
(43) Pub. Date: Apr. 14, 2005

(54) Context sensitive advertisement delivery framework

(75) Inventor: Michel K. Bowman-Amuah, Colorado Springs, CO (US)

Correspondence Address: OPPENHEIMER WOLFF & DONNELLY, LLP (ACCENTURE), PLAZA VII, SUITE 3300, 45 SOUTH SEVENTH STREET, MINNEAPOLIS, MN, 55402-1609, US

(73) Assignee: Accenture Global Services, GmBH

(21) Appl. No.: 10/647,411

(22) Filed: Aug. 25, 2003

Related U.S. Application Data
(63) Continuation of application No. 10/307,120, filed on Nov. 27, 2002, now abandoned.
(60) Provisional application No. 60/333,587, filed on Nov. 27, 2001.

(51) Int. Cl. G06F 17/60

(52) U.S. Cl. 705/14

(57) ABSTRACT

A system, method and computer program product are provided for context-sensitive advertising. Initially, a signal is received from a mobile wireless device. Next, an identifier associated with the mobile wireless device is identified after which a state of the mobile wireless device is ascertained. Still yet, a location of the mobile wireless device is determined. The identifier, state, and location are then updated in a profile database utilizing a context engine. Next, the location of the mobile wireless device is associated with a landmark in the profile database. Further, advertisements are selected from an advertisement database based on the identifier, state, location, and landmark of the mobile wireless device utilizing the context engine. In use, the advertisements are transmitted to the mobile wireless device.

### RELATED APPLICATIONS

This application is related to co-pending applications titled “SERVICE CONTROL ARCHITECTURE” and “SERVICE CONTROL FRAMEWORK FOR SEAMLESS TRANSFER OF A MULTIMEDIA CONFERENCE OVER DIFFERENT MEDIA” which are each invented by Michel K. Bowman-Amuah and filed concurrently herewith under attorney docket number 60021-376201 and 60021-376101, respectively, and which are incorporated herein by reference in their entirety for all purposes.

### FIELD OF THE INVENTION

The present invention relates to network advertising, and more particularly to advanced network advertising enabled by advanced service control.

### GENERAL BACKGROUND AND STATE OF THE ART

Most advertising schemes attempt to improve the cost effectiveness of advertising by first identifying their customers and then targeting their advertisements to them. Today, it is desirable for advertisers to use the same tactics to target users connected to a wide area network, such as the Internet. In order to effectively target advertisements to users of computers connected to a wide area network, the advertisers must use some method to deliver advertisements.

After a delivery scheme has been adopted, the advertisers must use some distinguishing criteria, such as age, gender, occupation, hobbies, other interests, purchases, etc. to identify and sort out potential customers. It is well known that information regarding the web sites visited or items purchased by a computer user connected to the wide area network may be used to identify potential customers.

One common method used to identify prior visitors of a particular web site is for the network server to generate and transmit a “cookie” to the user & a point-of-sale (POS) computer when the user visits a web site for the first time. Later when the user returns to the web site, the network server detects the “cookie” and regards the user as a return visitor. With this information, the network server can then transmit new data or advertisements to the user not originally transmitted to the user during the first visit.

Ideally, it is desirable to know the network address of the user & POS computer so that advertisements may be transmitted directly to the computer when connected to the wide area network. If the user has established a permanent account setup at a network service provider, also known as an Internet Service Provider (a.k.a. ISP), a permanent numerical address (called an Internet Protocol Address, a.k.a. IP) is assigned to the user. In some instances, personal information about the user or users of the computer is also given to the ISP. Every time the user uses a computer to connect to the wide area network, the user & POS computer is identified by the user & POS IP.

If a permanent account has not been set up by a network service provider, the user must use a client software program, such as AMERICA ON-LINE 4.0, which contains account information and a log-on password which are downloaded to a central server each time the user connects to the network. With each “log-on” connection, a temporary, numerical address is assigned to the user & POS computer. In either situation, the electronic device & POS identification information or the numerical address is obtained. The electronic device & POS identification information and personal information about the user, of course, are useful to advertisers so that they can deliver their advertisements to the users.

More recently, wireless network services have become available which enable users to use their mobile electronic devices to connect to the wide area network while traveling. This user mobility spawns a new need for targeting advertisements at the user when traveling. There is thus a need for collecting information regarding the specific location of these electronic devices as well as other factors that may be used to more effectively target advertisements to mobile users.

### INVENTION SUMMARY

A system, method and computer program product are provided for context-sensitive advertising. Initially, a signal is received from a mobile wireless device. Next, an identifier associated with the mobile wireless device is identified after which a state of the mobile wireless device is ascertained. Still yet, a location of the mobile wireless device is determined. The identifier, state, and location are then updated in a profile database utilizing a context engine. Next, the location of the mobile wireless device is associated with a landmark in the profile database. Further, advertisements are selected from an advertisement database based on the identifier, state, location, and landmark of the mobile wireless device utilizing the context engine. In use, the advertisements are transmitted to the mobile wireless device.

In one embodiment, the wireless device may include a personal digital assistant (PDA), a palm-top computer, a lap-top computer, and/or a cellular phone. Further, the wireless device may utilize cellular technology. It should be noted that the aforementioned signal may be a ping and/or call signal.

In another embodiment, the location may include a cell identifier. Such cell identifier may further have an alias associated therewith. As an option, the alias may include HOME, WORK, and/or PLEASURE. Moreover, the state may include ON or OFF.

In still another embodiment, the location of the mobile wireless device may be associated with a longitude coordinate and a latitude coordinate in the profile database.

In one certain embodiment, the method may be carried out utilizing a service control architecture. In particular, the service control architecture may include a database, a profiler module, an application module, a network resource module, a presentation module, and a policy server.

### BRIEF DESCRIPTION OF THE DRAWINGS

FIG. 1 illustrates an architecture by which context-sensitive advertising may be implemented.

FIG. 2 illustrates a method for providing context-sensitive advertising in the context of the architecture of FIG. 1.

FIGS. 3 and 4 illustrate an exemplary service control architecture with which the embodiment of FIGS. 1 and 2 may optionally be implemented.

### DETAILED DESCRIPTION OF THE PREFERRED EMBODIMENTS

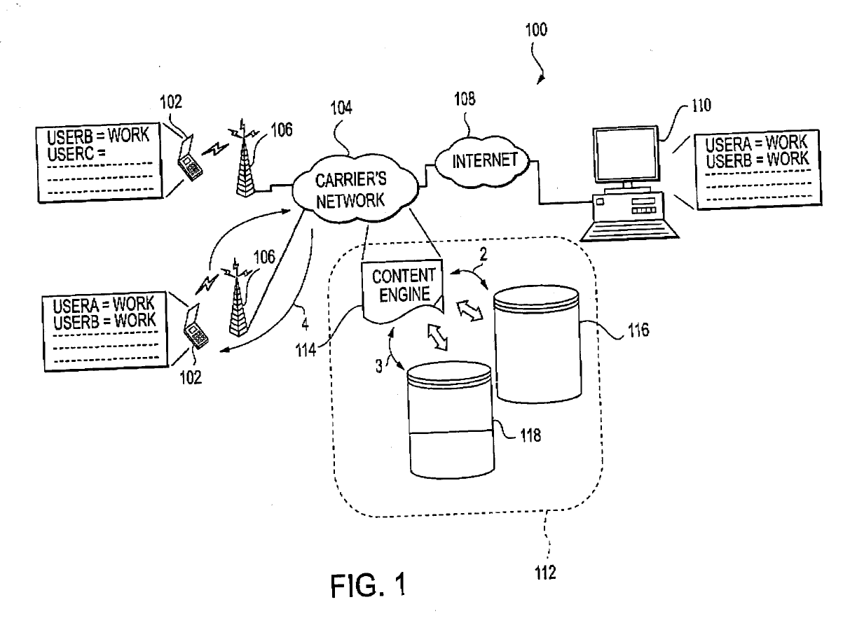

FIG. 1 illustrates an architecture 100 by which context-sensitive advertising may be implemented. As shown, a plurality of mobile devices 102 is provided which are capable of communicating with a carrier network 104. In the context of the present description, the mobile devices 102 may include any device capable of communicating while exhibiting enhanced mobility. Just by way of example, the mobile devices 102 may include a cellular phone, a wireless personal digital assistant (PDA), palm-top computer, lap-top computer, or the like.

The carrier network 104 may include any type of telecommunication network capable of allowing communication of the mobile devices 102 with other entities coupled to the carrier network 104. In the context of the example where the mobile devices 102 include cellular telephones, such communication may occur via various cell towers 106. Of course, any other desired communication medium (i.e. satellite, etc.) may be used per the desires of the user.

One entity coupled to the carrier network 104 is a packet switched network 108. In the context of the present embodiment, the network 108 may take any form including, but not limited to a local area network (LAN), a wide area network (WAN) such as the Internet, etc. Coupled to the network 108 may be a plurality of computers 110. Of course, the computers 110 may take any form including, but not limited to desktop computers, lap-top computers, hand-held computers, or any other type of computing hardware/software.

Given this network architecture 100, a user may selectively communicate using the mobile devices 102 and computers 110. As the user moves from device-to-device and location-to-location, the present embodiment is capable of providing context-sensitive advertising to the user.

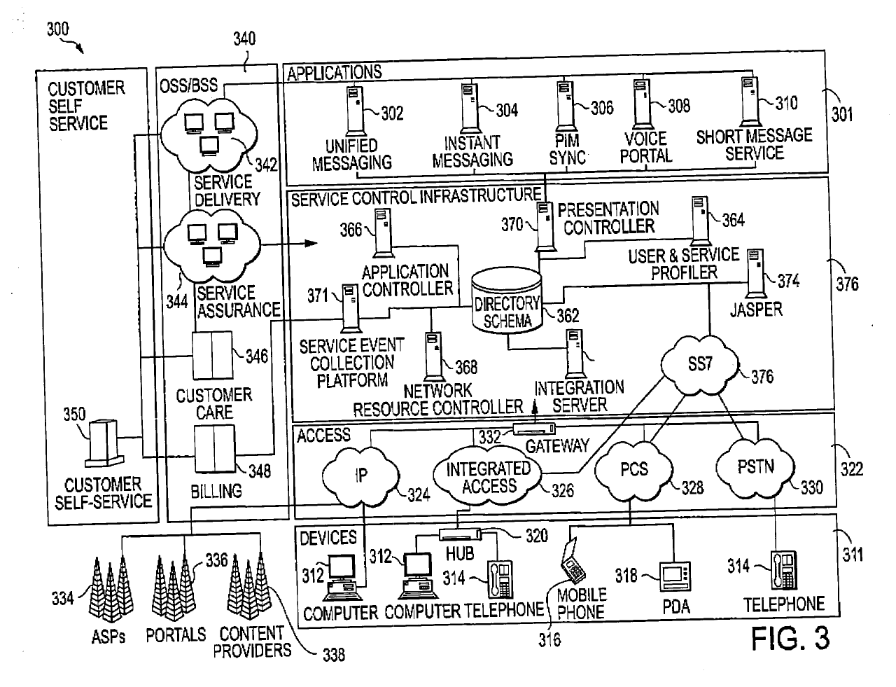

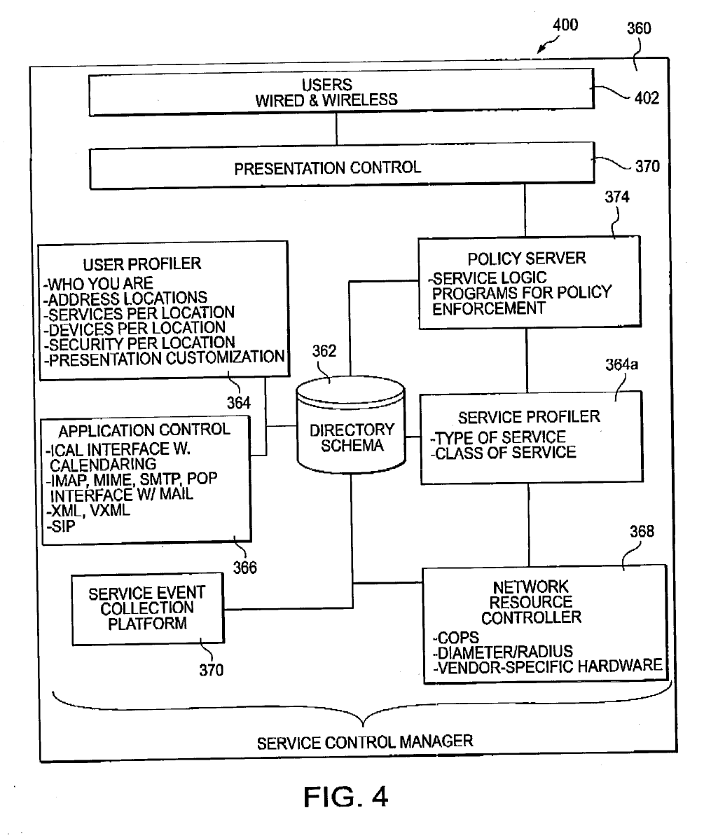

This is accomplished by way of a service control architecture 112 shown coupled to the networks 104 and 108. It should be noted that the service control architecture 112 may include any set of servers, databases, etc. operating as components of the network architecture 100. One particular example of a service control architecture 112 will be set forth during reference to FIGS. 3 and 4. In use, the service control architecture 112 collects information associated with the user, the mobile devices 102, and the computers 110 to provide context-sensitive advertising to the user.

In one embodiment, the service control architecture 112 may include a context engine 114 coupled to the networks 104 and 108 for communicating with the mobile devices 102 and computers 110. The service control architecture 112 is further coupled to a directory database 116, or “profile” database, including profile information. Table 1 illustrates exemplary profile information that may be stored in the directory database 116.

TABLE 1
UserA Profile
Cell = 138-A
Alias = Work
Landmark = Town Center
Latitude = Xx
Longitude = Yy
State = DND
UserB Profile
Cell = 148-B
Alias = Work-out

As shown in Table 1, such profile information includes a plurality of user profiles each associated with a particular user. Each user profile in turn includes a plurality of locations. In one embodiment where the mobile devices 102 utilize cellular technology, such locations take the form of cells which are areas defined by the cell towers 106. Each of the cells has a cell identifier that is also stored in the directory database 116.

The user profiles further include a landmark which may include any man-made structure, historical site, natural wonder, etc. associated with the location of the mobile devices 102 or computers 110. Further, the user profiles include a pair of latitude and longitude coordinates associated with the location of the mobile devices 102 or computers 110. Still yet, the user profiles may include an alias associated with the location of the mobile devices 102 or computers 110. In the alternative, the aliases may simply be associated with one of the particular mobile devices 102 or computers 110 that is currently being used.

Also stored in the directory database 116 is a state of the mobile devices 102 and computers 110 which may be tracked as part of the user profiles. In one embodiment, such state may indicate a status as simple as ON and OFF. In the alternative, the state may include a comprehensive view of the status of the mobile devices 102 and computers 110. Just by way of example, the state may include MOBILE, DESKTOP, WORK, HOME, PLEASURE, USER1, USER2, USER3, etc. The manner in which such user profiles are managed and used by the context engine 114 of the service control architecture 112 will be set forth hereinafter in greater detail.

Also included is an advertising database 118 for storing content that may take the form of advertising. In the context of the present description, advertising may include any solicitation, information, etc. relating to available products or services. Table 2 illustrates exemplary advertising content.

TABLE 2
Longitude = Xx-Zz
Latitude = Yy-Zz
Ad Contexts: Store1, Company1
Longitude = Kk-Zz
Latitude = Ll-Zz
Ad Contexts: Store2, Company2

As shown, the advertising database 118 includes a plurality of sets of advertising content. Each set of advertising content is associated with a particular location, which is identified by a specific longitude and latitude coordinate. It should be noted that the advertising database 118 may include sets of advertising content that also correspond with the particular cell, landmark, alias, status of the user profiles, etc.

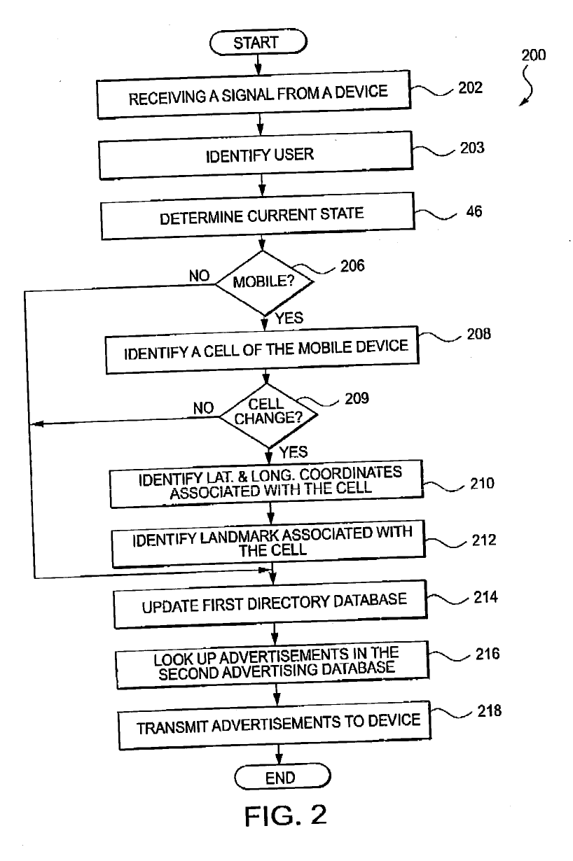

FIG. 2 illustrates a method 200 for providing context-sensitive advertising in the context of the architecture 100 of FIG. 1. Initially, in operation 202, a signal is received from one of a plurality of devices associated with a particular user. Such signal may include a standard ping signal serving just to convey profile information, or the signal may initiate a communication with another party.

Communicated with or by such signal is the identifier associated with the device. Note operation 203. Such identifier identifies the user associated with the device. Further ascertained from the signal is the state of the device and the associated user, as indicated in operation 204. Next, it is determined in decision 206 if the device is a mobile device. As mentioned earlier, a mobile device may include a cellular phone, a wireless PDA, or the like.

If the device is determined to be mobile in decision 206, a location of the device is identified based on the signal that is received. Note operation 208. As mentioned earlier, this may be accomplished by identifying the cell identifier of the particular cell in which the mobile device is located. It is then determined in decision 209 as to whether the device has changed cells since a previous signal was received.

If it is determined that the device has changed cells, the context engine 114 is adapted to determine the latitude and longitude coordinates corresponding to the cell in which the mobile device is located. Note operation 210. It should be noted that the latitude and longitude coordinates may also include a range of coordinates associated with the cell. In a similar manner, the context engine 114 serves to determine any landmark associated with the cell in which the mobile device is located. See operation 212. Such information may be retrieved from a separate database correlating the cell identifiers with the latitude and longitude coordinates, and the landmarks.

With this information ascertained, the directory database 116 is updated with the current state, cell identifier, corresponding latitude and longitude coordinates, and any corresponding landmarks to be associated with the current user. Note operation 214. It should be understood that the directory database 116 may simply be updated with the current state if it is determined in decision 206 that the device is not mobile, or that the device has not changed cells in decision 209.

In operation 216, advertisements are looked up in the advertisement database 118 based on at least one of the cell identifier, state, latitude and longitude coordinates, or landmark utilizing the context engine 114. Thereafter, in operation 218, the advertisements may be transmitted to the device.

More information will now be set forth regarding an exemplary service control architecture 112 that may be used to implement the method 200 of FIG. 2. It should be noted, however, that the service control architecture 112 set forth below is meant for illustrative purposes only, and should not be construed as limiting in any manner.

FIGS. 3 and 4 illustrate an exemplary service control architecture environment 300 with which the present embodiment may optionally be implemented. As shown, a plurality of applications 301 are provided including a unified messaging application 302, instant messaging application 304, PIM Sync application 306, voice portal application 308, and short message service application 310. Of course, any other desired applications may be provided per the desires of the user.

Further provided is a plurality of devices 311 including computers 312, telephones 314, and mobile devices such as mobile phones 316, personal digital assistants 318 (PDAs), etc. Some of such devices 311 may be coupled via a hub 320. Coupled to the devices 311 is a plurality of access networks 322. The access networks 322 include a Internet Protocol (IP) network 324, an integrated access network 326, personal communication services (PCS) network 328, and a public switched telephone network (PSTN) 330.

Each of the access networks 322 is in turn coupled to a gateway 332. Also provided is a plurality of application service providers (ASPs) 334, portals 336, and content providers 338 which are coupled to the Internet Protocol (IP) network 324.

With continuing reference to FIG. 3, a plurality of Business Support Systems and Operations Support Systems (OSS/BSS) 340 are included. In particular, the OSS/BSS 340 include a service delivery system 342 coupled to the applications 301 and a service assurance system 644 coupled thereto. The OSS/BSS 340 also include a customer care system 346 and a billing system 348. Each of the OSS/BSS 340 is coupled to a customer self-service system 350.

Next provided is a service control architecture 360 for providing intention-based, context-sensitive services to mobile users in the context of the service control architecture environment 300. First provided is a database 362. Also included is a profiler module 364 coupled to the database 362. As will become apparent, the profiler module 364 is adapted for collecting a state of a user along with profile information. Such profile information includes an identity, location, available services per location, devices per location, and/or security per location. In use, the profiler module 364 communicates the profile information to the database 362 for storage therein.

Also included is an application module 366 coupled to the database 362. The application module 366 includes a plurality of application program interfaces for interfacing with the applications 301 via the database 362. The application module 366 is adapted for allocating application resources to the applications 301 based on the profile information stored in the database 362 in a manner that will be set fort hereinafter in greater detail.

Associated therewith is a network resource module 368 coupled to the database 362 and a plurality of network routers (not shown). The network resource module 368 serves for configuring the network routers based on the profile information stored in the database 362 and the application resources allocated to the applications 301. Also coupled to the database 362 is a presentation module 370 which is in turn coupled to the applications 301. In use, the presentation module 370 is adapted for tailoring an output of the applications 301 based on the profile information.

Coupled to the billing system 348 of the OSS/BSS 340 and the database 362 is a service event collection platform 371 for tracking various events in the service control architecture environment 300 via the database 362. Such events may then be aggregated, correlated, etc. for transmission to the billing system 348 for billing purposes. Also provided is an integration server 372.

A policy server 374 is coupled to the database 362 and a Signal System 7 (SS7) network 376, the application module 366, the network resource module 368, and the presentation module 370 for controlling the operation thereof in accordance with policies identified utilizing the profile information.

The service control architecture 360 thus communicates with the OSS/BSS 340, the access networks 322 and the devices 311 via the gateway 332. Further, the service control architecture 360 communicates with the applications 301 via the presentation controller 370, and the billing system 340 via the service event collection platform 371. By this design, the service control architecture 360 serves as a hub for the service control architecture environment 300 for providing Artificial Intelligent Networks (AIN)-like capabilities in an environment including a wide range of networks 322 and devices 311.

FIG. 4 illustrates a detailed overview 400 of the service control architecture 360 and the related services associated with each of the modules thereof. Each of such modules is coupled to a plurality of users 402 utilizing the devices 311 of FIG. 3. In one embodiment, the database 362 is codified based on JAVA and/or JNDI. The database 362 provides a common data model that represents the logical relationship and data hierarchy between the users 402 and his/her services, devices and the features and functionality associated with such services. In use, the database 362 may be used to manage a user's Quality of Service (QoS), personalization and security on a per-service basis.

The profiler module 364 may include a user profiler 364 and a service profiler 364a. The profiler module 364 is adapted for collecting a state of a user along with profile information. Such profile information includes an identity, location, available services per location, devices per location, and/or security per location. The profile information may further include presentation customization for a particular user. In one embodiment, the profiler module 364 includes a data entry I/O front end application written using JAVA code. As an option, the profiler module 364 may run on a portal server (i.e. iPlanet™, etc.) that collects information and stores the same in the database 362.

As mentioned earlier, associated with the profiler module 364 is a service profiler 364a. The service profiler 364a is adapted for evaluating input and updating service attributes for a type of service [i.e. IP telephony (voice, fax over IP, etc.); IP/VPN unified messaging; calendaring; etc.] and a class of service (i.e. platinum, gold, silver, etc.).

Service attributes may be used to define application and network resources required per service type and class of service. In use, the profiler module 364 and the service profiler 364a communicate the user and service profile information to the database 362 for storage therein.

The application module 366 includes a plurality of application program interfaces for interfacing with the applications 301 via the database 362. The application module 366 may be written using JAVA (JNDI)-based code that allocates application resources using the application program interfaces.

The application module 366 is thus adapted for allocating application resources to the applications 301 based on the profile information (i.e. the service attributes, etc.) stored in the database 362 in a manner that will be set fort hereinafter in greater detail.

The network resource module 368 may include a Nortel® scripting language on a Shasta® platform. In use, the network resource module 368 communicates with network routers to configure parameters aligned to the profile information stored in the database 362 and the application resources allocated to the applications 301. It should be noted that the network resource module 368 is further capable of implementing and enforcing the service policies to which the user has subscribed. Still yet, the network resource module 368 can dynamically allocate bandwidth based on the stored profile information.

The presentation module 370 may optionally include Java (J2EE) code with directory APIs as well as HTML and XML style sheets running on a server (i.e. iPlanet™ server, regular server, etc.). By managing channels of content and views of presentation that a user has profiled in the directory, the presentation module 370 is adapted for tailoring an output of the applications 301 based on the profile information. In particular, the presentation module 370 may be utilized to implement requests made by the user such as content channel requests (i.e. sports, stocks, news, etc.) or views (color, fonts, etc.).

The policy server 374 includes a service logic execution program (i.e. JAVA-based) that executes the policies associated with each individual service. In one exemplary implementation, the policy server 374 may be executed in two parts: 1) Shasta® box for network resource module 368 and 2) iPlanet® for application and presentation modules 366 and 370. In use, service control by the policy server 374 provides quality of service (QoS) and class of service (CoS); personalization and contextualization; and security through use of a user-defined policy; a directory; and authentication, authorization, and access control; respectively.

It should be noted that the service control architecture may take many forms, and may be used in the context of various applications. For more information, reference may be made to co-pending applications entitled “SERVICE CONTROL ARCHITECTURE” and “SERVICE CONTROL FRAMEWORK FOR SEAMLESS TRANSFER OF A MULTIMEDIA CONFERENCE OVER DIFFERENT MEDIA” which are each invented by Michel K. Bowman-Amuah and filed concurrently herewith under attorney docket numbers 60021-376201 and 60021-376101, respectively, and which are incorporated herein by reference in their entirety for all purposes.

While the specification describes particular embodiments of the present invention, those of ordinary skill can devise variations of the present invention without departing from the inventive concept.

1. A method for context-sensitive advertising, comprising:
receiving a signal from a mobile wireless device;
identifying an identifier associated with the mobile wireless device; ascertaining a state of the mobile wireless device;
determining a location of the mobile wireless device;
updating the identifier, state, and location in a profile database utilizing a context engine;
associating the location of the mobile wireless device and a landmark in the profile database;
selecting advertisements from an advertisement database based on the identifier, state, location, and landmark of the mobile wireless device utilizing the context engine; and
transmitting the advertisements to the mobile wireless device.

2. The method as recited in claim 1, wherein the wireless device is selected from the group consisting of a personal digital assistant, a palm-top computer, a lap-top computer, and a cellular phone.

3. The method as recited in claim 1, wherein the wireless device utilizes cellular technology.

4. The method as recited in claim 1, wherein the signal includes a ping signal.

5. The method as recited in claim 1, wherein the signal includes a call signal.

6. The method as recited in claim 1, wherein the location includes a cell identifier.

7. The method as recited in claim 6, wherein the cell identifier has an alias associated therewith.

8. The method as recited in claim 7, wherein the alias is selected from the group consisting of HOME, WORK, and PLEASURE.

9. The method as recited in claim 1, wherein state includes at least one of ON and OFF.

10. The method as recited in claim 1, wherein the identifier, the state, and the location are transmitted utilizing the network.

11. The method as recited in claim 1, and further comprising associating the location of the mobile wireless device, and a longitude coordinate and a latitude coordinate in the profile database.

12. The method as recited in claim 1, wherein the method is carried out utilizing a service control architecture.

13. The method as recited in claim 12, wherein the service control architecture includes a database, a profiler module, an application module, a network resource module, a presentation module, and a policy server.

14. The method as recited in claim 12, wherein the service control architecture includes a database; a profiler module coupled to the database, the profiler module adapted for collecting a state of a user along with profile information selected from the group consisting of identity, location, available services per location, devices per location, and security per location, wherein the profiler module communicates the profile information to the database for storage therein; an application module coupled to the database and including a plurality of application program interfaces for interfacing with a plurality of applications, the application module adapted for allocating application resources to the applications based on the profile information stored in the database; a network resource module coupled to the database and a plurality of network routers, the network resource module adapted for configuring the network routers based on the profile information stored in the database and the application resources allocated to the applications; a presentation module coupled to the database, the presentation module adapted for tailoring an output of the applications based on the profile information; and a policy server coupled to the database, the application module, the network resource module, and the presentation module for controlling the operation thereof in accordance with policies identified utilizing the profile information.

15. A computer program product for context-sensitive advertising, comprising:
computer code for receiving a signal from a mobile wireless device;
computer code for identifying an identifier associated with the mobile wireless device; ascertaining a state of the mobile wireless device;
computer code for determining a location of the mobile wireless device;
computer code for updating the identifier, state, and location in a profile database utilizing a context engine;
computer code for associating the location of the mobile wireless device and a landmark in the profile database;
computer code for selecting advertisements from an advertisement database based on the identifier, state, location, and landmark of the mobile wireless device utilizing the context engine; and
computer code for transmitting the advertisements to the mobile wireless device.

16. The computer program product as recited in claim 15, wherein the wireless device is selected from the group consisting of a personal digital assistant, a palm-top computer, a lap-top computer, and a cellular phone.

17. The computer program product as recited in claim 15, wherein the wireless device utilizes cellular technology.

18. The computer program product as recited in claim 15, wherein the signal includes a ping signal.

19. The computer program product as recited in claim 15, wherein the signal includes a call signal.

20. The computer program product as recited in claim 15, wherein the location includes a cell identifier.

21. The computer program product as recited in claim 20, wherein the cell identifier has an alias associated therewith.

22. The computer program product as recited in claim 21, wherein the alias is selected from the group consisting of HOME, WORK, and PLEASURE.

23. The computer program product as recited in claim 15, wherein state includes at least one of ON and OFF.

24. The computer program product as recited in claim 15, wherein the identifier, the state, and the location are transmitted utilizing the network.

25. The computer program product as recited in claim 15, and further comprising computer code for associating the location of the mobile wireless device, and a longitude coordinate and a latitude coordinate in the profile database.

26. The computer program product as recited in claim 15, wherein the computer program product is executed utilizing a service control architecture.

27. The computer program product as recited in claim 26, wherein the service control architecture includes a database, a profiler module, an application module, a network resource module, a presentation module, and a policy server.

28. The computer program product as recited in claim 26, wherein the service control architecture includes a database; a profiler module coupled to the database, the profiler module adapted for collecting a state of a user along with profile information selected from the group consisting of identity, location, available services per location, devices per location, and security per location, wherein the profiler module communicates the profile information to the database for storage therein; an application module coupled to the database and including a plurality of application program interfaces for interfacing with a plurality of applications, the application module adapted for allocating application resources to the applications based on the profile information stored in the database; a network resource module coupled to the database and a plurality of network routers, the network resource module adapted for configuring the network routers based on the profile information stored in the database and the application resources allocated to the applications; a presentation module coupled to the database, the presentation module adapted for tailoring an output of the applications based on the profile information; and a policy server coupled to the database, the application module, the network resource module, and the presentation module for controlling the operation thereof in accordance with policies identified utilizing the profile information.

29. A system for context-sensitive advertising, comprising:
a mobile wireless device for transmitting a signal;
a context engine in communication with the mobile wireless device for identifying an identifier associated with the mobile wireless device, ascertaining a state of the mobile wireless device, and determining a location of the mobile wireless device;
a first database coupled to the context engine for storing the identifier, state, and location of the mobile wireless device;
said context engine further adapted for associating the location of the mobile wireless device and a landmark in the profile database;
a second database coupled to the context engine for storing advertisements that are retrieved by the context engine based on the identifier, state, location, and landmark of the mobile wireless device; and
wherein the advertisements are transmitted to the mobile wireless device.

30. The computer program product as recited in claim 29, wherein the context engine is a component of a service control architecture including a profiler module, an application module, a network resource module, a presentation module, and a policy server.

31. A method for context-sensitive advertising, comprising:
receiving a signal from one of a plurality of devices associated with a single user;
identifying an identifier associated with the device from which the signal is received;
ascertaining a state of the device from which the signal is received;
determining if the device is mobile;
if the device is determined to be mobile,
determining a location of the device from which the signal is received,
associating the location of the device from which the signal is received, and a longitude coordinate and a latitude coordinate in the profile database, and
associating the coordinates of the device from which the signal is received, and a landmark in the profile database;
updating the profile database utilizing a context engine;
selecting advertisements from an advertisement database based on the identifier, state, location, or landmark utilizing the context engine; and
transmitting the advertisements to the device.
